(19) United States
(12) Patent Application Publication
(10) Pub. No.: US 2024/0370653 A1
(43) Pub. Date: Nov. 7, 2024

(54) MATCHING DESCRIPTIVE TEXTS BASED ON EXPERIENCE AND SERVICE REQUESTS

(71) Applicant: Connoisseur Technology Holdings, LLC, Denver, CO (US)

(72) Inventors: Ryan Newburn, Centennial, CO (US); Ognjen Grba, Calgary (CA); Patrick Ivy, Lakewood, CO (US)

(73) Assignee: Connoisseur Technology Holdings, LLC, Denver, CO (US)

(21) Appl. No.: 18/652,126

(22) Filed: May 1, 2024

Related U.S. Application Data
(60) Provisional application No. 63/499,286, filed on May 1, 2023.

(51) Int. Cl. G06F 40/30; G06F 18/2321

(52) U.S. Cl. CPC G06F 40/30; G06F 18/2321

(57) ABSTRACT

A method described herein may include receiving a first text from a first user associated with a service provider, wherein the first text indicates an experience of the service provider. The method may include receiving a second text from a second user associated with a consumer, wherein the second text indicates a service requested by the consumer. An AI engine may determine a degree to which the first text and the second text are associated with same or similar topics. A match score may be generated based on the determination of the AI engine, wherein the match score indicates a degree to which the experience of the service provider matches the service requested by the consumer. The match score may be output to the first user or the second user.

### CROSS-REFERENCES TO RELATED APPLICATIONS

This application claims the benefit of U.S. Provisional Patent Application No. 63/499,286, entitled “MATCHING DESCRIPTIVE TEXTS BASED ON EXPERIENCE AND SERVICE REQUESTS,” filed May 1, 2023, and hereby incorporated by reference in its entirety.

### BACKGROUND

The advent of artificial intelligence (AI) has opened up an entire field of possibilities not previously available. However, the usefulness of an AI is limited by its training. With proper training, AI is capable of performing tasks and analyses not previously possible by humans alone. One field where AI shows promise is in the field of natural language processing (NLP). The uses of NLP by AI engines have not yet been fully realized or explored. For example, only nominal work has been done to determine the capabilities of AI and NLP in pairing consumers with service providers. Search engines only provide a superficial glance at the possibilities. Much work is still needed.

### SUMMARY

A method described herein may include receiving first text data from a first user device associated with a service provider, wherein the first text data indicates an experience of the service provider providing a consumer service. The method may include receiving second text data from a second user device associated with a consumer, wherein the second text data indicates a service requested by the consumer. The first and second text data may be provided to an artificial intelligence (AI) engine that is trained to determine a degree to which the first text data and the second text data are associated with the same or similar topics. The AI engine may be trained to determine a match score based on such similarity. The AI engine may determine the degree to which the first text data and the second text data are associated with same or similar topics. The match score may be generated based on the determination of the AI engine, wherein the match score indicates a degree to which the experience of the service provider matches the service requested by the consumer. The match score may be output to the first user device or the second user device.

The first text data or the second text data may include an electronic document or a natural language (NL) text. The AI engine may be trained to determine outcomes or intents associated with texts and determine whether an individual outcome matches an individual intent. The method may include determining, by the AI engine, one or more outcomes associated with the first text data, determining, by the AI engine, one or more intents associated with the second text data, and determining, by the AI engine, a degree to which the one or more outcomes associated with the first text data match the one or more intents associated with the second text data. The match score may be based on this determination.

The AI engine may be trained to generate a simplified summary of a complex text data. The method may include generating, by the AI engine, summary data based on the first text data. The summary data may be output to the second user device. The AI engine may be trained to generate a technical summary of a non-technical or technical text. The method may include generating, by the AI engine, technical data based on the second text data. The technical data may be output to the first user device.

The AI engine may be trained to replace specific entity information in a textual input with generic identifiers in a summary. The method may include generating, by the AI engine, summary data based on the first text data or the second text data. The summary data may include the generic identifiers in place of the specific entity information in the first text data or second text data.

The first text data may include a technical document prepared for another purpose besides generating the match score. The second text data may include an NL text string prepared for the purpose of generating the match score.

The AI engine may be trained to identify licensing required of the service provider to provide a specific service. The method may include determining, by the AI engine, whether an individual topic associated with the second text data has a licensing requirement. The licensing requirement may be output to the second user device. The method may include receiving, from the first user device, license data associated with the service provider that indicates a license of the service provider to provide the service, determining, by the AI engine, whether an individual topic associated with the second text has a licensing requirement, and generating the match score based on whether the license data associated with the service provider matches the licensing requirement.

A method described herein may include receiving first text data from a first user device associated with a service provider. The first text data may indicate an experience of the service provider. The method may include receiving license data from the first user device that indicates a license of the service provider to provide a particular consumer service. Second text data may be received from a second user device associated with a consumer. The second text data may indicate a service requested by the consumer. The first text data, the license data, and the second text data may be provided to an AI engine. The AI engine may be trained to determine, based on the first text data and the second text data, a degree to which the experience of the service provider matches the service requested by the consumer, and determine, based on the license data and the second text data, whether the license of the service provider meets a licensing requirement of the service requested by the consumer. The degree to which the experience of the service provider matches the service requested by the consumer may be determined by the AI engine. The AI engine may determine whether the license of the service provider meets the licensing requirement of the service requested by the consumer. A single match score may be generated based on the determinations of the AI engine. The match score may indicate the degree to which the experience of the service provider matches the service requested by the consumer. The match score may indicate whether the license of the service provider meets the licensing requirement of the service requested by the consumer. The match score may be output to the first user device or the second user device.

A method described herein may include receiving license data from a first user device associated with a service provider. The license data may indicate a license of a service provider. Text data may be received from a second user device associated with a consumer. The text data may indicate a service requested by the consumer. The license data and the text data may be provided to an AI engine, which may be trained to determine, based on the license data and the text data, whether the license of the service provider meets the licensing requirement of the service requested by the consumer. The AI engine may determine, based on the license data and the text data, whether the license of the service provider meets the licensing requirement of the service requested by the consumer. A match score may be generated based on the determination of the AI engine. The match score may indicate whether the license of the service provider meets the licensing requirement of the service requested by the consumer. The match score may be output to the first user device or the second user device.

The licensing requirement may include a geographic restriction that requires licensing within a particular geographic region. The method may include receiving, from the second user, geographic data that indicates a geographic location of the consumer or the second user device. The determination of the AI engine may be based on the geographic location. The geographic data may include a location output of a global positioning sensor associated with the second user device. The geographic data may include an internet protocol address of the second user device.

The match score may be binary. For example, the match score may indicate the license of the service provider either meets the licensing requirement or does not meet the licensing requirement.

The AI engine may be trained to generate an experience summary of an experience of the service provider related to the service requested by the consumer. The method may include receiving, from the first user device, experience data that indicates the experience of the service provider. The experience data may be provided to the AI engine, which may generate the experience summary. The experience summary may be output to the second user device. The experience summary may be generated and output in response to the license of the service provider meeting the licensing requirement.

### BRIEF DESCRIPTION OF THE DRAWINGS

The present description will be understood more fully when viewed in conjunction with the accompanying drawings of various examples of the systems and methods described herein. The description is not meant to limit the systems and methods to the specific examples. Rather, the specific examples depicted and described are provided for explanation and understanding of the systems and methods described herein. Throughout the description the drawings may be referred to as drawings, figures, and/or FIGs.

FIG. 1 illustrates a matching system for consumers and service providers.

FIG. 2 illustrates a device schematic for various devices used in the matching system.

FIG. 3 illustrates a method of generating a match score for a consumer and a service provider.

FIG. 4 illustrates a method of generating a match score for a consumer and a service provider based on the intent of the consumer and outcomes achieved by the service provider.

FIG. 5 illustrates a method of generating a match score for a consumer and a service provider with a summary of the service requested or the service provider's experience.

FIG. 6 illustrates a method of generating a match score for a consumer and a service provider with further information about licensing required for the service requested by the consumer.

FIG. 7 illustrates a method of generating a match score for a consumer and a service provider based on the experience level and licensing of the service provider.

FIG. 8 illustrates a method of matching a consumer with an appropriately licensed service provider.

FIG. 9 illustrates a method of matching a consumer with a service provider licensed in a particular geographic region.

### DETAILED DESCRIPTION

The systems and methods as disclosed herein will become better understood through a review of the following detailed description in conjunction with the figures. The detailed description and figures provide merely examples of the various embodiments of the methods. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional system for providing consumers information about service providers may include a generic search engine that scrapes a service provider's online profile or website for key words. For example, a consumer may type a string of words into a search bar of a general search engine or a search engine of a particular website. The search engine may parse the string of words into keywords and may search websites or service provider profiles for the keywords. In some cases, a website may include wrote profiles for service providers. The profiles may include check boxes for particular services. When a consumer searches for a service, the search engine may determine which of the pre-defined services the consumer's search most closely relates to and show to the consumer the service provider profiles that have those pre-defined services marked.

In some cases, service providers may only be able to serve clients in a particular geographic region. This may be due to the physical location of the service provider or licensing requirements of a particular profession. For example, a general building contractor may be limited to accepting projects in a particular state where the general contractor is licensed, or a plumbing sub-contractor may be limited to accepting projects in a particular metropolitan area where the plumbing sub-contractor's hub of operations is located. In some professions, certain services may be provided to any consumer in any geographic location, whereas other services may only be provided in particular geographic regions where the service provider is licensed. For example, an attorney licensed in a particular jurisdiction may only be able to represent clients in litigation within that jurisdiction, but may provide legal counsel and services in a variety of areas to clients regardless of where the client is located. In the medical profession, a doctor may be limited in which patients the doctor may accept by the particular board certifications held by the doctor.

Regardless of licensing or certification requirements, consumers generally demand service providers with experience related to the particular problem the consumer is facing. A consumer needing to build an addition to their home wants a general contractor experienced in building additions, including obtaining all the permits and doing the customization needed to complete the project. A consumer needing advice on a particular tax matter wants an accountant that has successfully advised previous clients with the same issue. And so on.

Current solutions simply do not offer the kind of granularity consumers demand. This leads to frustration on the consumer's part in finding a service provider, and may lead to a poor match, with the consumer guessing what their needs are and what the service provider's expertise is. This can ultimately cost time and money for the consumer and/or the service provider.

Implementations of the systems and methods described herein may address some or all of the problems described above. A method described herein may include receiving a first text from a first user device associated with a service provider, wherein the first text indicates an experience of the service provider. The method may further include receiving a second text from a second user device associated with a consumer, wherein the second text indicates a service requested by the consumer. The first or second text may be represented as data provided to the AI engine. An artificial intelligence (AI) engine may be trained to determine a degree of similarity between the first and second text, and to generate a match score based on such similarity. The AI engine may determine a degree to which the first text and the second text are associated with same or similar topics. A match score may be generated based on the determination of the AI engine, wherein the match score indicates a degree to which the experience of the service provider matches the service requested by the consumer. The match score may be output to the first user device or the second user device.

The first text or the second text may include an electronic document or a natural language (NL) text. The AI engine may trained to determine outcomes or intents associated with texts and determine whether an individual outcome matches an individual intent. The method may include determining, by the AI engine, one or more outcomes associated with the first text, determining, by the AI engine, one or more intents associated with the second text, and determining, by the AI engine, a degree to which the one or more outcomes associated with the first text match the one or more intents associated with the second text. The match score may be based on this determination.

The AI engine may be trained to generate a simplified summary of a complex text. The method may include generating, by the AI engine, the simplified summary, such as through summary data, based on the first text. The simplified summary may be output to the second user device. The AI engine may be trained to generate a technical summary of a non-technical or technical text. The method may include generating, by the AI engine, the technical summary, such as through technical data, based on the second text. The technical summary may be output to the first user device.

The AI engine may be trained to replace specific entity information in a textual input with generic identifiers in a summary. The method may include generating, by the AI engine, the summary based on the first text or the second text. The summary may include generic identifiers in place of specific entity information in the first text or second text.

The first text may include a technical document prepared for another purpose besides generating the match score. The second text may include an NL text string prepared for the purpose of generating the match score.

The AI engine may be trained to identify licensing required of the service provider to provide a specific service. The method may include determining, by the AI engine, whether an individual topic associated with the second text has a licensing requirement. The licensing requirement may be output to the second user device. The method may include receiving, from the first user device, license data indicative of a license of the service provider related to a consumer service, determining, by the AI engine, whether an individual topic associated with the second text has a licensing requirement, and generating the match score based on whether the license data associated with the service provider matches the licensing requirement.

A method described herein may include receiving a first text from a first user device associated with a service provider. The first text may indicate an experience of the service provider. The method may include receiving a license indicator from the first user device that indicates a license of the service provider. A second text may be received from a second user device associated with a consumer. The second text may indicate a service requested by the consumer. The first text, the license indicator, and the second text may be provided to an AI engine. The AI engine may be trained to determine a degree to which the experience of the service provider matches the service requested by the consumer, and determine, based on the second text, whether the license of the service provider meets a licensing requirement of the service requested by the consumer. The degree to which the experience of the service provider matches the service requested by the consumer may be determined by the AI engine. The AI engine may determine whether the license of the service provider meets the licensing requirement of the service requested by the consumer. A single match score may be generated based on the determinations of the AI engine. The match score may indicate the degree to which the experience of the service provider matches the service requested by the consumer. The match score may indicate whether the license of the service provider meets the licensing requirement of the service requested by the consumer. The match score may be output to the first user device or the second user device.

A method described herein may include receiving a license indicator from a first user device associated with a service provider. The license indicator may indicate a license of a service provider. A text may be received from a second user device associated with a consumer. The text may indicate a service requested by the consumer. The license indicator and the text may be provided to an AI engine, which may be trained to determine whether the license of the service provider meets the licensing requirement of the service requested by the consumer. The AI engine may determine whether the license of the service provider meets the licensing requirement of the service requested by the consumer. A match score may be generated based on the determination of the AI engine. The match score may indicate whether the license of the service provider meets the licensing requirement of the service requested by the consumer. The match score may be output to the first user device or the second user device.

The licensing requirement may include a geographic restriction that requires licensing within a particular geographic region. The method may include receiving, from the second user device, a geographic indicator that indicates a geographic location of the consumer or the second user device. The determination of the AI engine may be based on the geographic location. The geographic indicator may include a location output of a global positioning sensor associated with the second user device. The geographic indicator may include an internet protocol address of the second user device.

The match score may be binary. For example, the match score may indicate the license of the service provider either meets the licensing requirement or does not meet the licensing requirement.

The AI engine may be trained to generate an experience summary of an experience of the service provider related to the service requested by the consumer. The method may include receiving, from the first user device, experience text that indicates the experience of the service provider. The experience text may be provided to the AI engine, which may generate the experience summary. The experience summary may be output to the second user device. The experience summary may be generated and output in response to the license of the service provider meeting the licensing requirement.

The methods described herein may allow a consumer to find a service provider with the experience and qualifications needed to address the consumer's specific problem. For example, an attorney that specializes in litigation (i.e., a service provider) may upload a set of documents the attorney has prepared through the course of litigation. A consumer may provide the system with a description of a particular legal matter the consumer is facing. The AI may process the attorney's set of documents and the consumer's description and determine whether the attorney has experience handling the consumer's particular problem. The system may generate a match score that shows the consumer how well the attorney's experience aligns with the consumer's legal issue. The system may also provide the consumer with a summary of the attorney's experience, which may better enable the consumer to understand whether the attorney can meet the consumer's needs. This may allow the consumer to select the best attorney the first time, saving time and money and ensuring the consumer's legal issue is handled in the best possible manner by the most qualified attorney.

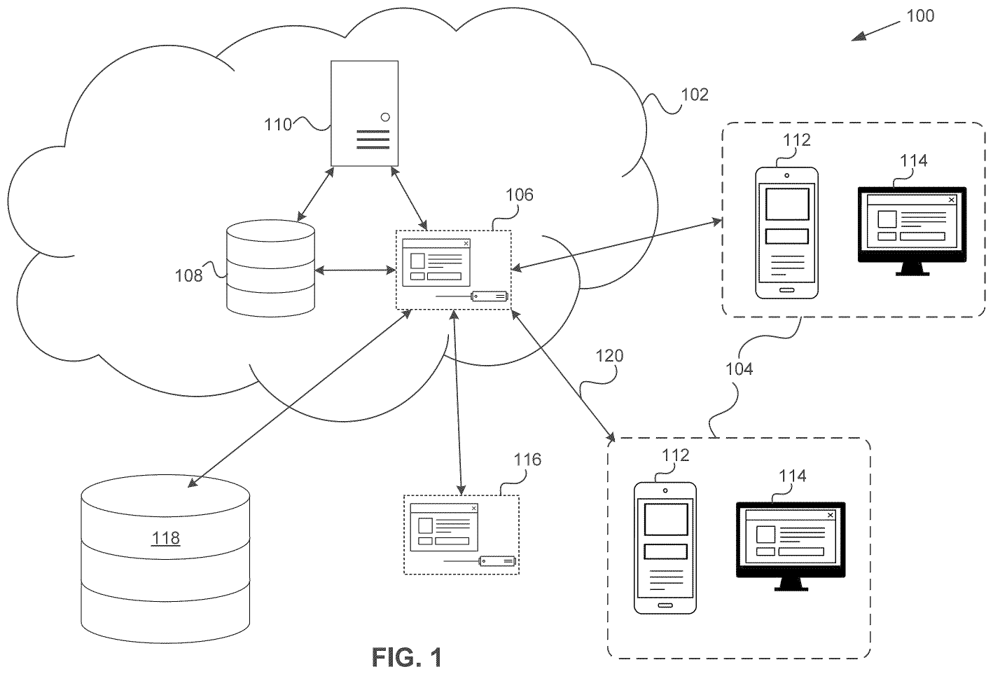

FIG. 1 illustrates a matching system 100. The matching system 100 may include a cloud-based data handling system 102 and a user device 104. The cloud-based data handling system 102 may include an application server 106, a database 108, and a data server 110. The user device 104 may include one or more devices associated with user profiles of the matching system 100, such as a smartphone 112 and/or a personal computer 114. The matching system 100 may include external resources such as an external application server 116 and/or an external database 118. The various elements of the matching system 100 may communicate via various communication links 120. An external resource may generally be considered a data resource owned and/or operated by an entity other than an entity that utilizes the cloud-based data handling system 102 and/or the user device 104.

The matching system 100 may be web-based. The user device 104 may access the cloud-based data handling system 102 via an online portal set up and/or managed by the application server 106. The matching system 100 may be implemented using a public internet. The matching system 100 may be implemented using a private intranet. Elements of the matching system 100, such as the database 108 and/or the data server 110, may be physically housed at a location remote from an entity that owns and/or operates the matching system 100. For example, various elements of the matching system 100 may be physically housed at a public service provider such as a web services provider. Elements of the matching system 100 may be physically housed at a private location, such as at a location occupied by the entity that owns and/or operates the matching system 100.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links 120, may refer to any of the aforementioned indirect communication links.

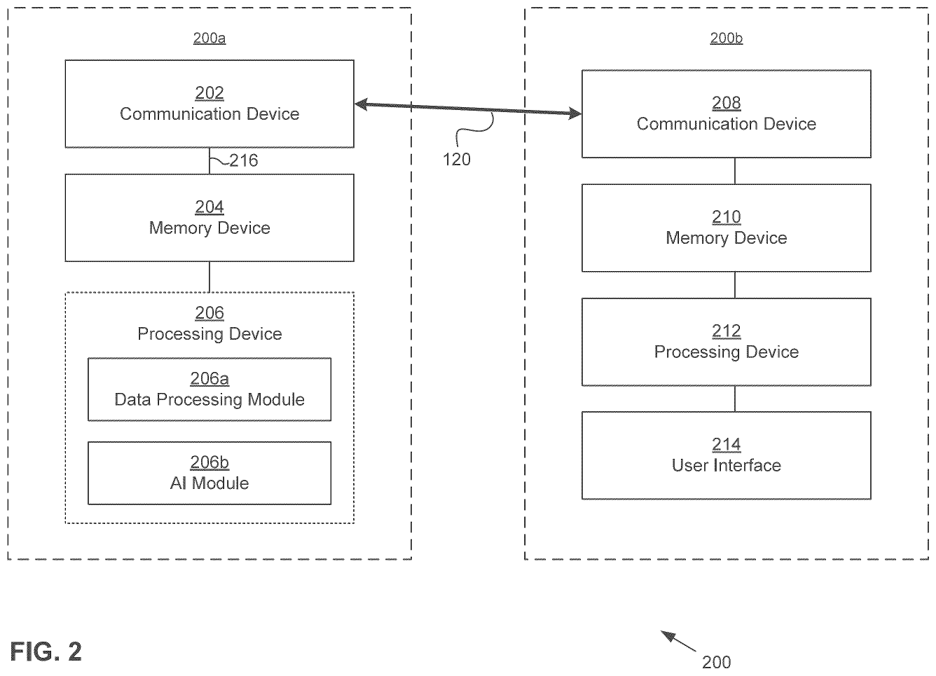

FIG. 2 illustrates a device schematic 200 for various devices used in the matching system 100. A server device 200a may include a communication device 202, a memory device 204, and a processing device 206. The processing device 206 may include a data processing module 206a and an AI module 206b, where module refers to specific programming that governs how data is handled by the processing device 206. The user device 200b may include a communication device 208, a memory device 210, a processing device 212, and a user interface 214. Various hardware elements within the server device 200a and/or the user device 200b may be interconnected via a system bus 216. The system bus 216 may be and/or include a control bus, a data bus, and address bus, and so forth. The communication device 202 of the server device 200a may communicate with the communication device 208 of the user device 200b.

The data processing module 206a may handle inputs from the user device 200a. The data processing module 206a may cause data to be written and stored in the memory device 204 based on the inputs from the user device 200b. The data processing module 206a may retrieve data stored in the memory device 204 and output the data to the user device 200a via the communication device 202.

The AI module 206b may determine or generate data to output to the user device 200b. The AI module 206b may be trained to compare different texts and determine a degree to which the texts concern the same or similar topics. The AI module 206b may be trained to generate a match score that reflects the degree to which the texts concern the same or similar topics. The AI module 206b may be trained to generate a match score that reflects the degree to which the texts concern different topics. The AI module 206b may be trained to determine outcomes or intents associated with texts and determine whether an individual outcome matches an individual intent. For example, a text provided by a consumer may reflect an intent of the consumer, and a text provided by a service provider may reflect one or more outcomes achieved by the service provider for a different project. As a more specific example, the text provided by the consumer may indicate the consumer desires to obtain a patent for a new processor. The service provider may be a patent attorney, and the text provided by the patent attorney may be a patent written and prosecuted by the attorney. The AI module 206b may be trained to recognize whether the patent written by the patent attorney concerns processors.

The AI module 206b may be trained to generate a simplified summary of a complex text. For example, the AI module 206b may be trained to receive an engineering description created by an engineer and simplify the engineering description so that it is comprehensible by the consumer. As used herein, “simplify” means to output text written to a particular reading level, such as may be common with consumers in a particular field. For some technical fields or service fields, simplify may mean to explain jargon or terms of art, or to replace such terms with text recognizable by consumers not familiar with such jargon or terms of art. For some technical fields or service fields, simplify may mean to express analyses as conclusions. In general, simplify means to put technical or complex text in terms understandable to an average consumer relative to a particular field.

The AI module 206b may be trained to generate a technical summary of a non-technical or technical text. For example, a consumer may provide a description of a legal issue they are facing. The AI module 206b may be trained to generate a summary of the legal issue using legal terms of art or references to laws or regulations familiar to an attorney experienced in a particular field. As another example, a consumer may provide a description of a medical issue they are facing, and the AI module 206b may be trained to generate a summary of the medical issue using medical terms of art a doctor is familiar with.

The AI module 206b may be trained to replace specific entity information in a textual input with generic identifiers in a summary. For example, a document provided by a service provider may include confidential client information such as the client's personal identifying information. The AI module 206b may be trained to replace such personal identifying information with generic identifiers. As a specific example, the AI module 206b may be trained to replace a name with the term “Client” or “J. Doe.”

The AI module 206b may be trained to identify licensing required of the service provider to provide a specific service. For example, text provided by a consumer may indicate the consumer has a legal issue involving federal court. The AI module 206b may be trained to identify the consumer should be matched with an attorney admitted to practice law before the particular court overseeing the legal issue. As another example, the text provided by the consumer may indicate the consumer is dealing with a particular medical issue. The AI module 206b may be trained to identify the consumer should be matched with a doctor having a particular board certification qualifying the doctor to handle the consumers medical issue.

The AI module 206b may be trained to determine a degree to which the experience of the service provider matches the service requested by the consumer. For example, a consumer may request a bid for re-plumbing an existing structure. The AI module 206b may be trained to process text associated with a plumbing service provider and determine the plumbing service provider has experience plumbing new structures. The AI module 206b may be trained to process text associated with a second plumbing service provider and determine the second plumbing service provider has experience plumbing existing structures. The AI module 206b may generate an output that indicates the second plumbing service provider's experience correlates more closely with the service requested by the consumer than the first plumbing service provider.

In other implementations, the AI module 206b may be trained to determine the relative extent of experience of service providers. For example, a consumer may request a service related to personal injury litigation. The AI module 206b may receive texts from two attorneys with experience litigating personal injury suits. The text from the first attorney may indicate the first attorney has conducted 10 jury trials, and the text from the second attorney may indicate the second attorney has conducted 30 jury trials. The AI module 206 may generate an output that indicates the second attorney has more experience conducting jury trials, or is more qualified, than the first attorney.

The server device 200a may be representative of the cloud-based data handling system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the user device 200b may be representative of the user device 104. The user device 200b may be representative of the smartphone 112. The user device 200b may be representative of the personal computer 114. The memory device 210 may store application instructions that, when executed by the processing device 212, cause the user device 200b to perform various functions associated with the instructions, such as retrieving data, processing data, receiving input, processing input, transmitting data, and so forth.

As stated above, the server device 200a and the user device 200b may be representative of various devices of the matching system 100. Various of the elements of the matching system 100 may include data storage and/or processing capabilities. Such capabilities may be rendered by various electronics for processing and/or storing electronic signals. One or more of the devices in the matching system 100 may include a processing device. For example, the cloud-based data handling system 102, the user device 104, the smartphone 112, the personal computer 114, the external application server 116, and/or the external database 118 may include a processing device. One or more of the devices in the matching system 100 may include a memory device. For example, the cloud-based data handling system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the matching system 100 may include data communication capabilities. Such capabilities may be rendered by various electronics for transmitting and/or receiving electronic and/or electromagnetic signals. One or more of the devices in the matching system 100 may include a communication device, e.g., the communication device 202 and/or the communication device 208. For example, the cloud-based data handling system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the matching system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the matching system 100, including the server device 200a and/or the user device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the matching system 100 and/or various elements of the matching system described above. For example, inputs indicated as being received in a method may be input at the user device 104 and/or received at the cloud-based data handling system 102 and/or server device 200a. Determinations made in the methods may be outputs generated by the processing device 206 based on inputs stored in the memory device 204. Outputs generated in the methods may be output to the memory device 204 and/or the user device 200b. In general, data described in the methods may be stored and/or processed by various elements of the data analysis system 100, the server device 200a, and/or the user device 200b. As used herein, the terms “text,” “indicator,” and/or other similar terms may refer to data representing such text, indicator, etc.

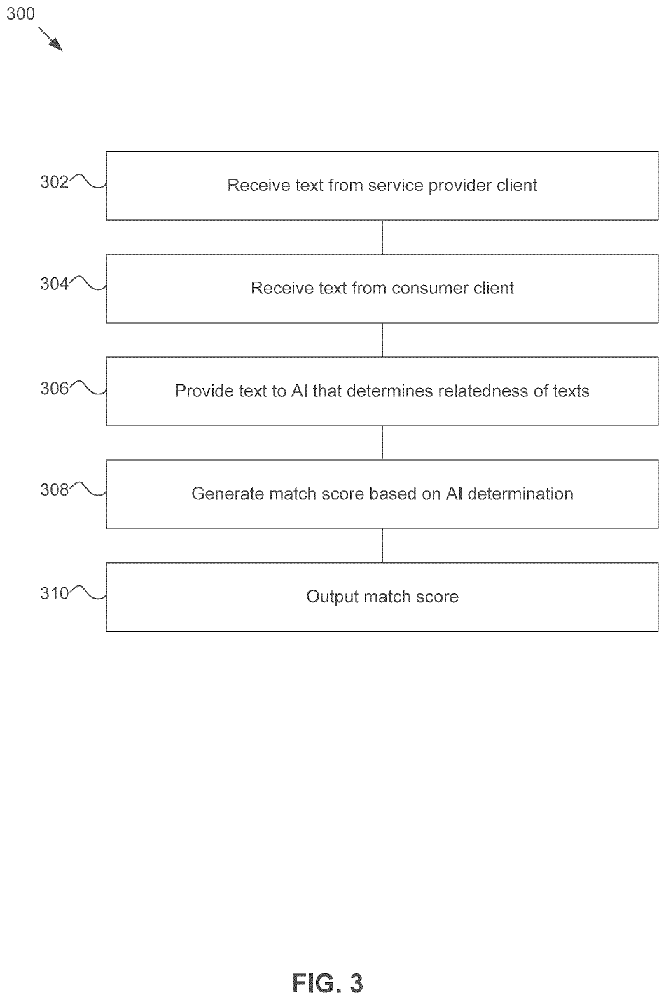

FIG. 3 illustrates a method 300 of generating a match score for a consumer and a service provider. The method 300 may include, at block 302, receiving a first text from a first user device associated with a service provider. The first text may indicate an experience of the service provider. The first text may include an electronic document or an NL text. For example, the service provider may be an attorney. The first text may include text from a document prepared by the attorney. The first text may include a text from a set of documents prepared by the attorney. The first text may refer to the document or the set of documents. As another example, the service provider may be an accountant. The first text may include a document, or text from a document, prepared by the accountant. In general, the service provider may be any of a variety of service providers, and the first text may be one or more documents, or text from one or more documents, which documents were prepared by or on behalf of the service provider.

The method 300 may include, at block 304, receiving a second text from a second user device associated with a consumer. The second text may indicate a service requested by the consumer. The first text may include an electronic document or an NL text. The text may be written by the consumer, and may include a description of the service requested by the consumer. The text may be in an NL format. The text may be generated by a user device, such as the user device 104, in response to speech by the consumer. For example, the consumer may use a speech-to-text application on the user device to generate the second text. The second text may be a document. For example, the second text may be a legal document such as a contract, and the service requested by the consumer may be to have the contract reviewed and explained by an attorney.

The first and second texts may be provided to an AI engine (e.g., as may be implemented by AI module 206b), which may determine a degree to which the first text and the second text are associated with same or similar topics (block 306). For example, the consumer may request hair cutting services for men. The AI engine may determine, based on a text associated with a first hair cutting service provider, that the first hair cutting service provider has experience cutting men's hair. The AI engine may determine, based on a text associated with a second hair cutting service provider, that the second hair cutting service provider has experience cutting women's hair. The AI engine may determine the text associated with the first hair cutting service provider is more closely associated with the consumer's request text than the text associated with the second hair cutting service provider.

At block 308, a match score may be generated based on the determination of the AI engine. The match score may indicate a degree to which the experience of the service provider matches the service requested by the consumer. Using the immediately previous example of hair cutting, the match score may indicate the experience of the first hair cutting service provider more closely matches the service requested by the consumer than the second hair cutting service provider. For example, a match score for the first hair cutting service provider may be 100% (e.g., cuts hair and cuts men's hair), whereas a match score for the second hair cutting service provider may be 50% (e.g., cuts hair but doesn't cut men's hair). The match score may be output to the first user device or the second user device (block 310).

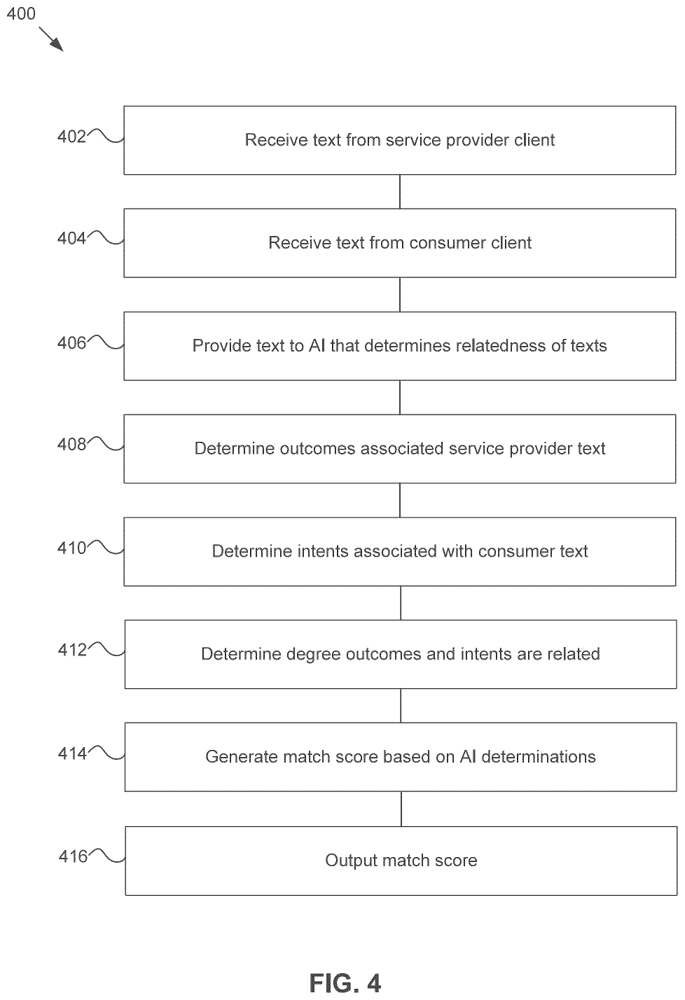

FIG. 4 illustrates a method 400 of generating a match score for a consumer and a service provider based on the intent of the consumer and outcomes achieved by the service provider. The method 400 may include, at block 402, receiving a first text from a first user device associated with a service provider. The first text may indicate an experience of the service provider. At block 404, the method 400 may include receiving a second text from a second user device associated with a consumer. The second text may indicate a service requested by the consumer.

The first and second texts may be provided to an AI engine (e.g., as may be implemented by AI module 206b), which may determine a degree to which the first text and the second text are associated with same or similar topics (block 406). The AI engine may further determine one or more outcomes associated with the first text (block 408) and one or more intents associated with the second text (block 410). The method 400 may include determining, by the AI engine, a degree to which the one or more outcomes associated with the first text match the one or more intents associated with the second text (block 412).

For example, the second text may be an NL text associated with a consumer describing that the consumer is facing a lawsuit and wants to negotiate a settlement without going to trial. The first text may be a document associated with an attorney describing how the attorney has successfully negotiated settlement in a variety of lawsuits. The AI engine may determine the intent of the consumer is to settle (e.g., intent variable=settle) and the outcomes achieved by the attorney are settlement (e.g., outcome variable=settlement). The AI engine may be trained to perform word stemming, e.g., settle stem=settl, settlement stem=settl, and further determine the intent and outcome variables are equal, e.g., settl=settl. The AI engine may be trained to perform lemmatization. For example, the intent variable may be equal to “good” (e.g., the consumer desires a good outcome), and the outcome variable may be equal to “win” (e.g., the service provider has winning results). The AI engine may equate “good” with “win.”

At block 414, a match score may be generated based on the determinations of the AI engine. The match score may indicate a degree to which the service requested by the consumer matches the experience of the service provider. The match score may indicate the degree to which the intent of the consumer matches the outcomes achieved by the service provider. The match score may be output to the first user device or the second user device (block 416).

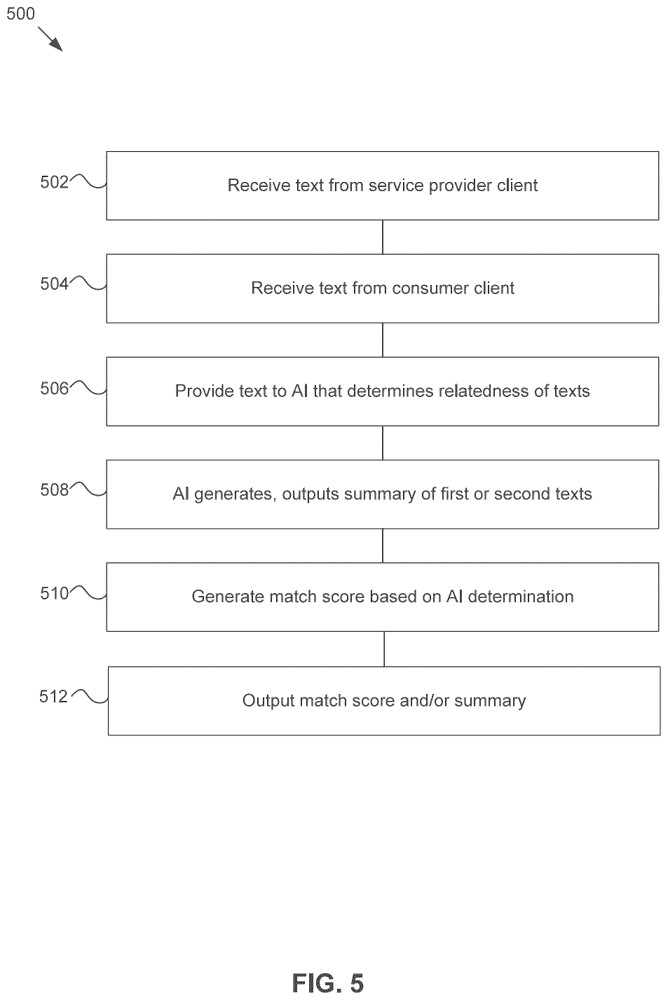

FIG. 5 illustrates a method 500 of generating a match score for a consumer and a service provider with a summary of the service requested or the service provider's experience. The method 500 may include, at block 502, receiving a first text from a first user device associated with a service provider. The first text may indicate an experience of the service provider. At block 504, the method 500 may include receiving a second text from a second user device associated with a consumer. The second text may indicate a service requested by the consumer.

An AI engine (e.g., as may be implemented by AI module 206b) may determine a degree to which the first text and the second text are associated with same or similar topics (block 506). The AI engine may further generate a summary of the first text or the second text (block 508). The AI engine may be trained to generate a simplified summary of a complex text. For example, the first text may be a technical text associated with an engineer, and the summary generated by the AI engine may be simplified to be understandable by a lay person or a common consumer of engineering services.

The AI engine may be trained to generate a technical summary of a non-technical or technical text. For example, the second text may be a description of a legal issue written by a consumer, or a legal document provided by the consumer. The summary generated by the AI engine may include technical terms that may allow an attorney to quickly understand what service the consumer is requesting. In some implementations, the technical summary may enable the service provider to understand what service is being requested even if the consumer is unsure. For example, the second text may be a building code citation. The consumer may or may not understand the reason for or resolution to the citation. The AI engine may generate a technical summary for a building contractor that enables the building contractor to quickly determine how to resolve the citation.

The AI engine may generate the summary in a manner that protects the privacy of entities associated with the summarized text. For example, the first or second text may include information or identifiers of a specific person or entity. The AI engine may be trained to recognize such information or identifiers and replace them with generic identifiers. The summary may, accordingly, include generic identifiers in place of specific entity information.

At block 510, a match score may be generated based on the determinations of the AI engine. The match score may indicate a degree to which the service requested by the consumer matches the experience of the service provider. The match score and/or the summary may be output to the first user device or the second user device (block 512).

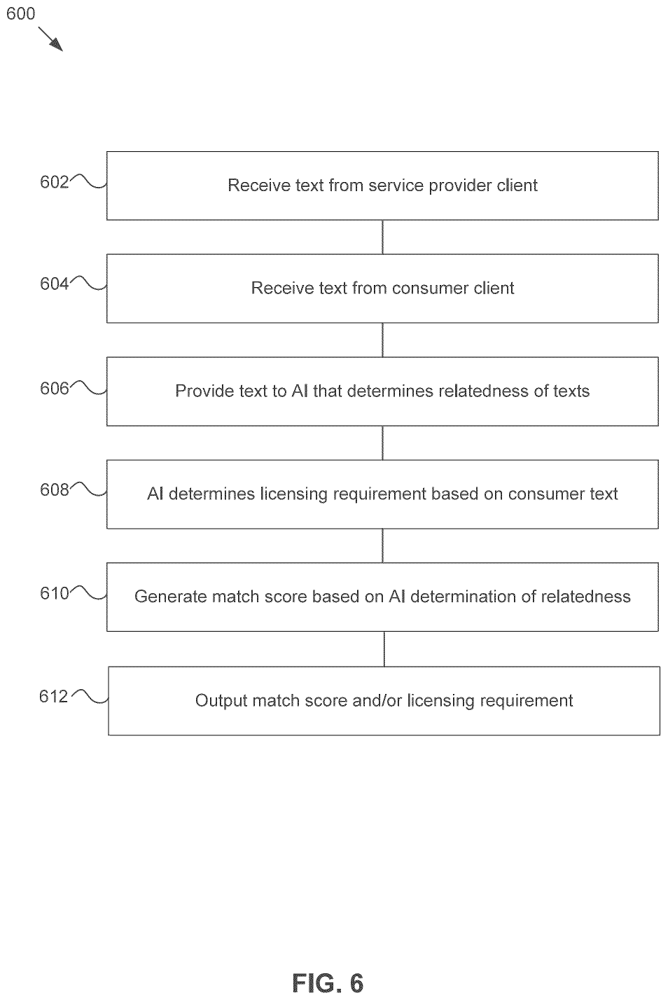

FIG. 6 illustrates a method 600 of generating a match score for a consumer and a service provider with further information about licensing required for the service requested by the consumer. The method 600 may include, at block 602, receiving a first text from a first user device associated with a service provider. The first text may indicate an experience of the service provider. At block 604, the method 500 may include receiving a second text from a second user device associated with a consumer. The second text may indicate a service requested by the consumer.

An AI engine (e.g., as may be implemented by AI module 206b) may determine a degree to which the first text and the second text are associated with same or similar topics (block 606). The AI engine may further determine whether an individual topic associated with the first text or second text has a licensing requirement (block 608). A match score may be generated based on the determinations of the AI engine (block 610). The match score may indicate a degree to which the service requested by the consumer matches the experience of the service provider. The match score may indicate whether an individual topic of the first or second text has a licensing requirement. The match score and/or the indicator of the licensing requirement may be output to the first user device or the second user device (block 612).

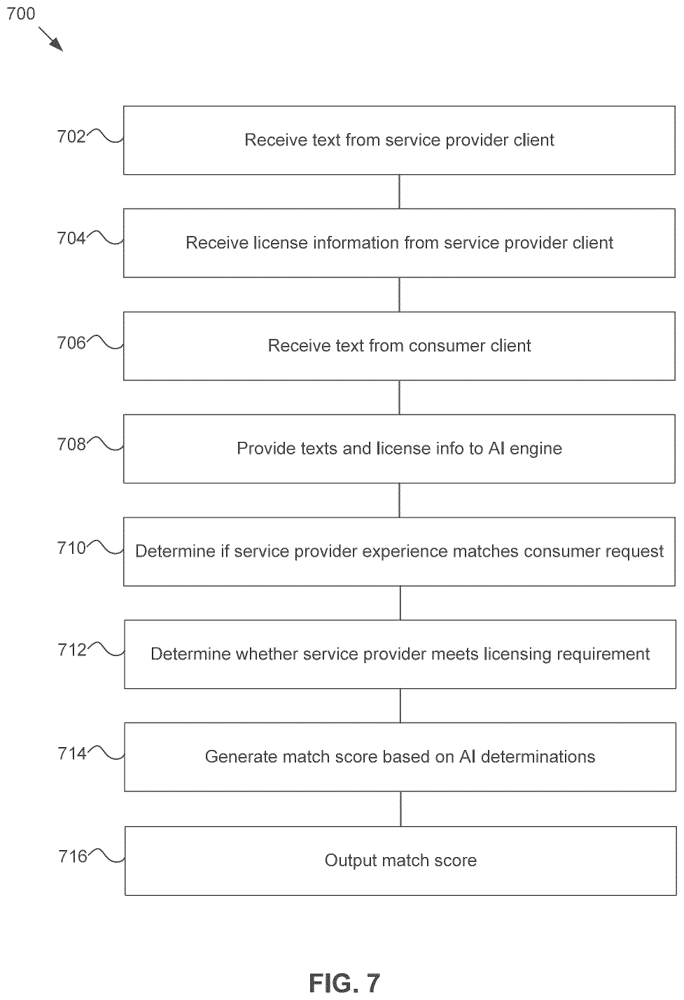

FIG. 7 illustrates a method 700 of generating a match score for a consumer and a service provider based on the experience level and licensing of the service provider. The method 700 may include receiving a first text from a first user device associated with a service provider (block 702). The first text may indicate an experience of the service provider. A license indicator may be received from the first user device that indicates a license of the service provider (block 704). A second text may be received from a second user device associated with a consumer (block 706). The second text may indicate a service requested by the consumer.

The first text, the license indicator, and the second text may be provided to an AI engine, such as may be implemented in the AI module 206b (block 708). The AI engine may be trained to determine a degree to which the experience of the service provider matches the service requested by the consumer, and determine, based on the second text, whether the license of the service provider meets a licensing requirement of the service requested by the consumer. The degree to which the experience of the service provider matches the service requested by the consumer may be determined by the AI engine (block 710). The AI engine may determine whether the license of the service provider meets the licensing requirement of the service requested by the consumer (block 712).

A single match score may be generated based on the determinations of the AI engine (block 714). The match score may indicate the degree to which the experience of the service provider matches the service requested by the consumer. The match score may indicate whether the license of the service provider meets the licensing requirement of the service requested by the consumer. The match score may be output to the first user device or the second user device (block 716).

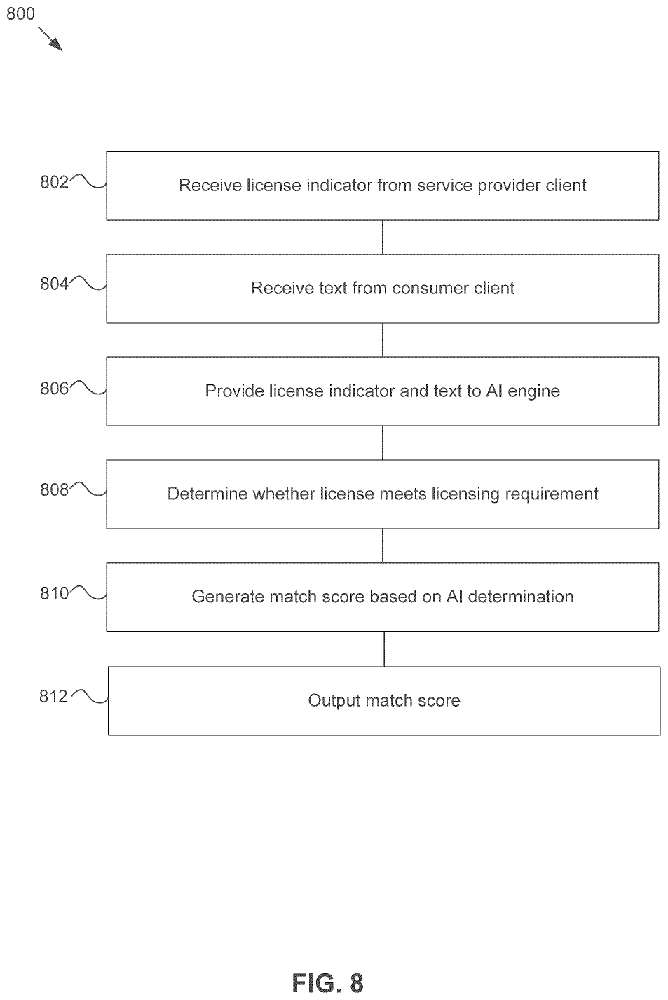

FIG. 8 illustrates a method 800 of matching a consumer with an appropriately licensed service provider. The method 800 may include receiving a license indicator from a first user device that is associated with a service provider (block 802). The license indicator may indicate a license or certification of a service provider whereby the service provider is permitted by a governing authority to perform services for consumers related to the license or certification. The license indicator may indicate the service provider has a certain degree of training related to certain services. The license indicator may indicate the service provider is qualified and/or competent to provide certain services.

The method 800 may include receiving a text from a second user device associated with a consumer (block 804). The text may indicate a service requested by the consumer. The license indicator and the second text may be provided to an AI engine, such as may be implemented in the AI module 206b (block 806). The AI engine may be trained to determine whether the license of the service provider meets the licensing requirement of the service requested by the consumer; The method 800 may accordingly include determining, by the AI engine, whether the license of the service provider meets a licensing requirement of the service requested by the consumer (block 808). A match score may be generated based on the determination of the AI engine (block 810). The match score may indicate whether the license of the service provider meets the licensing requirement of the service requested by the consumer. The match score may be output to the first user device or the second user device (block 812).

In some implementations, the match score may be binary such that the match score indicates the license of the service provider either meets the licensing requirement or does not meet the licensing requirement. For example, a “red” match score (e.g., the text of the match score is output in the color red) may indicate the service provider does not meet the licensing requirement, and a “green” match score may indicate the service provider meets the licensing requirement. As another example, the match score may be one or two words or set of words, such as “yes” (e.g., meets requirement) and “no” (e.g., does not meet requirement).

In some implementations, the AI engine may generate a summary of the experience of the service provider in response to the service provider meeting the license requirement for the service requested by the consumer. For example, text describing the experience of the service provider may be fed to the AI engine along with the license indicator and the text describing the service requested by the consumer. In response to the service provider's license not meeting the requirements of the service requested by the consumer, the AI engine may output a score that simply indicates the service provider is not qualified to help the consumer (or may not output anything at all and may simply move to analyzing another service provider's qualifications). In response to the service provider's license meeting the licensing requirements of the requested services, the AI engine may output a summary of the service provider's experience along with the match score. The AI engine may output a summary of the consumer's requested service. One or both of the summaries may be output to the first and/or second user devices.

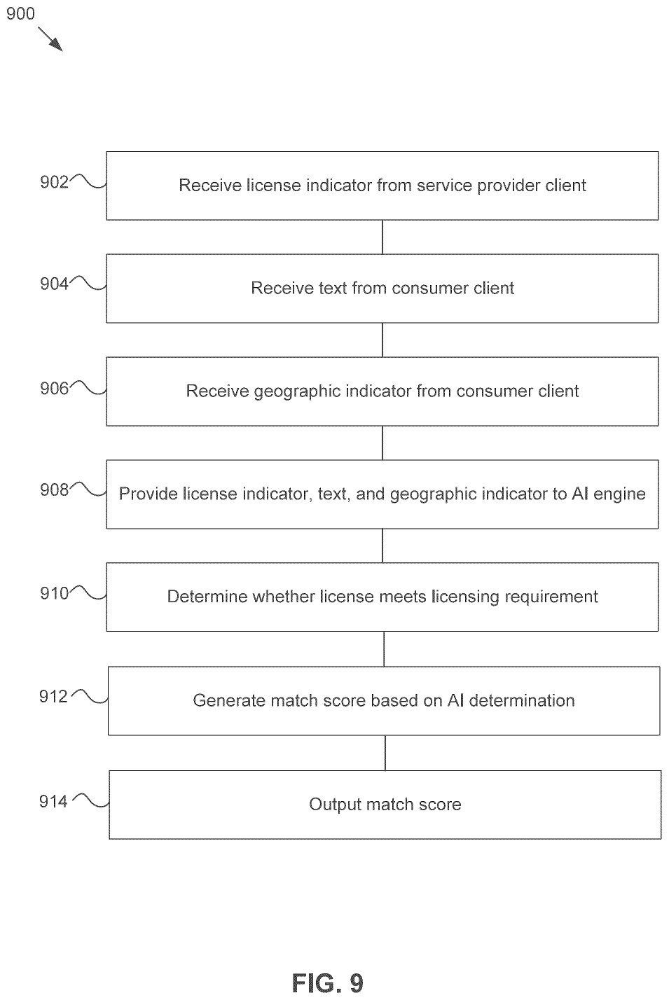

FIG. 9 illustrates a method 900 of matching a consumer with a service provider licensed in a particular geographic region. The method 900 may include receiving a license indicator from a first user device that is associated with a service provider (block 902). The license indicator may indicate the service provider is permitted to perform certain services for consumers in a particular geographic region. The method 900 may include receiving a text from a second user device associated with a consumer (block 904). The text may indicate a service requested by the consumer. A geographic indicator may be received from the second user device (block 906). The geographic indicator may indicate a geographic location of the consumer or the second user device. The geographic indicator may be associated with a geographic region within which the consumer requests particular services. The geographic indicator may, for example, include an output of a global positioning sensor of the second user device or an internet protocol address of the second user device.

The license indicator, the second text, and/or the geographic indicator may be provided to an AI engine, such as may be implemented in the AI module 206b (block 908). The AI engine may be trained to determine whether the license of the service provider meets the licensing requirement of the service requested by the consumer. The licensing requirement may, for example, include a geographic restriction that requires licensing within a particular geographic region. The method 900 may include determining, by the AI engine, whether the license of the service provider meets a licensing requirement of the service requested by the consumer (block 910). As a specific example, the license indicator may indicate an attorney is licensed to practice law in a particular state. The AI engine may determine, based on the text provided by the consumer, that the consumer needs an attorney licensed to practice law in their state. The geographic indicator may indicate the consumer is located where the attorney is licensed. A match score may be generated based on the determination of the AI engine (block 912). The match score may indicate whether the license of the service provider meets the licensing requirement of the service requested by the consumer. The match score may be output to the first user device or the second user device (block 914).

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

We claim:

1. A method, comprising:
receiving first text data from a first user device associated with a service provider, wherein the first text data indicates an experience of the service provider providing a consumer service;
receiving second text data from a second user device associated with a consumer, wherein the second text data indicates a service requested by the consumer;
determining, by an artificial intelligence (AI) engine, a degree to which the first text data and the second text data are associated with same or similar topics;
generating a match score based on the determination of the AI engine, wherein the match score indicates a degree to which the experience of the service provider matches the service requested by the consumer; and
outputting the match score to the first user device or the second user device.

2. The method of claim 1, wherein the first text data or the second text data comprises an electronic document.

3. The method of claim 1, wherein the first text data or the second text data comprises a natural language (NL) text.

4. The method of claim 1, wherein the AI engine is trained to determine outcomes or intents associated with texts and whether an individual outcome matches an individual intent, the method further comprising:
determining, by the AI engine, one or more outcomes associated with the first text;
determining, by the AI engine, one or more intents associated with the second text data; and
determining, by the AI engine, a degree to which the one or more outcomes associated with the first text data match the one or more intents associated with the second text data, wherein the match score is further based on this determination.

5. The method of claim 1, wherein in the AI engine is trained to generate a simplified summary of a complex text, the method further comprising:
generating, by the AI engine, summary data based on the first text data, wherein the first text data is indicative of the complex text, and wherein the summary data indicates the simplified summary; and
outputting the summary data to the second user device.

6. The method of claim 1, wherein the AI engine is trained to generate a technical summary of a non-technical or technical text, the method further comprising:
generating, by the AI engine, technical data based on the second text data, wherein the second text data is indicative of the non-technical or technical text, and wherein the technical data indicates the technical summary; and
outputting the technical data to the first user device.

7. The method of claim 1, wherein the AI engine is further trained to replace specific entity information in the first text data or the second text data with a generic identifier in a summary, the method further comprising generating, by the AI engine, summary data based on the first text data or the second text data, wherein the summary data is indicative of the generic identifier in place of the specific entity information in the first text data or second text data.

8. The method of claim 1, wherein the first text data comprises a technical document prepared for another purpose besides generating the match score.

9. The method of claim 1, wherein the second text data comprises an NL text string prepared for the purpose of generating the match score.

10. The method of claim 1, wherein the AI engine is further trained to identify licensing required of the service provider to provide a specific service, the method further comprising:
determining, by the AI engine, whether an individual topic associated with the second text data has a licensing requirement; and
outputting the licensing requirement to the second user device.

11. The method of claim 10, wherein the AI engine is further trained to identify licensing required of the service provider to provide a specific service, the method further comprising:
receiving, from the first user device, license data associated with the service provider;
determining, by the AI engine, whether an individual topic associated with the second text data has a licensing requirement; and
generating the match score further based on whether the license date associated with the service provider indicates the service provider meets the licensing requirement.

12. A method, comprising:
receiving first text data from a first user device associated with a service provider, wherein the first text data indicates an experience of the service provider providing a consumer service;
receiving license data from the first user device that indicates a license of the service provider to provide the consumer service;
receiving second text data from a second user device associated with a consumer, wherein the second text data indicates a service requested by the consumer;
providing the first text data, the license data, and the second text data to an artificial intelligence (AI) engine, wherein the AI engine is trained to:
determine, based on the first text data and the second text data, a degree to which the experience of the service provider matches the service requested by the consumer; and
determine, based on the license data and the second text data, whether the license of the service provider meets a licensing requirement of the service requested by the consumer;
determining, by the AI engine, the degree to which the experience of the service provider matches the service requested by the consumer;
determining, by the AI engine, whether the license of the service provider meets the licensing requirement of the service requested by the consumer;
generating a single match score based on the determinations of the AI engine, wherein the match score indicates:
the degree to which the experience of the service provider matches the service requested by the consumer; and
whether the license of the service provider meets the licensing requirement of the service requested by the consumer; and
outputting the match score to the first user device or the second user device.

13. A method, comprising:
receiving license data from a first user device associated with a service provider, wherein the license data indicates a license of a service provider to provide a consumer service;
receiving text data from a second user device associated with a consumer, wherein the text data indicates a service requested by the consumer;
providing the license data and the text data to an artificial intelligence (AI) engine, wherein the AI engine is trained to determine, based on the license data and the text data, whether the license of the service provider meets a licensing requirement of the service requested by the consumer;
determining, by the AI engine, whether the license of the service provider meets the licensing requirement of the service requested by the consumer;
generating a match score based on the determination of the AI engine, wherein the match score indicates whether the license of the service provider meets the licensing requirement of the service requested by the consumer; and
outputting the match score to the first user device or the second user device.

14. The method of claim 13, wherein the licensing requirement comprises a geographic restriction that requires licensing within a particular geographic region.

15. The method of claim 14, further comprising receiving, from the second user device, geographic data that indicates a geographic location of the consumer or the second user device, wherein the license data indicates the license of the service provider is geographically restricted, wherein the AI engine is further trained to determine whether the license of the service provider meets the licensing requirement based on the geographic data, and wherein the determination of the AI engine is further based on the geographic location.

16. The method of claim 15, wherein the geographic data comprises a location output of a global positioning sensor associated with the second user device.

17. The method of claim 15, wherein the geographic data comprises an internet protocol address of the second user device.

18. The method of claim 13, wherein the match score is binary such that the match score indicates the license of the service provider either meets the licensing requirement or does not meet the licensing requirement.

19. The method of claim 13, wherein the AI engine is further trained to generate experience summary data indicating an experience of the service provider related to the service requested by the consumer, the method further comprising:
receiving, from the first user device, experience data that indicates the experience of the service provider;
providing the experience data to the AI engine, wherein the AI engine is trained to generate the experience summary data based on the experience data;
generating the experience summary data by the AI engine; and
outputting the experience summary data to the second user device.

20. The method of claim 19, wherein the experience summary data is generated and output in response to the license of the service provider meeting the licensing requirement.
